(19) United States
(12) Patent Application Publication
(10) Pub. No.: US 2008/0103902 A1
(43) Pub. Date: May 1, 2008

(54) ORCHESTRATION AND/OR EXPLORATION OF DIFFERENT ADVERTISING CHANNELS IN A FEDERATED ADVERTISING NETWORK

(75) Inventors: Brian Burdick, Bellevue, WA (US); Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/762,632

(22) Filed: Jun. 13, 2007

Related U.S. Application Data
(60) Provisional application No. 60/862,969, filed on Oct. 25, 2006.

(51) Int. Cl. G06Q 30/00

(52) U.S. Cl. 705/14

(57) ABSTRACT

For a multi-party advertising exchange including advertising entities and publishing entities from different advertising networks, automatic apportioning of advertising transactions across inventory from different advertising channels is provided. Optimal combinations or advertising bundles of different channels are generated for the participant based on an analysis of inventory across different advertising channels for a given set of participation goals/constraints. A small portion of a participant's overall advertising expenditure can be held back for exploratory purposes to determine better combinations of advertising channels based on actual performance over time.

### CROSS REFERENCE TO RELATED APPLICATIONS

This application claims priority to U.S. Patent Application Ser. No. 60/862,969, filed on Oct. 25, 2006, entitled “DISTRIBUTED ARCHITECTURES FOR ONLINE ADVERTISING”, the entirety of which is incorporated herein by reference.

### TECHNICAL FIELD

The subject disclosure relates to the orchestration and/or exploration of advertising transactions across different advertising channels on behalf of participants of federated online advertising environments that integrate advertising entities across disparate advertising networks.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

Accordingly, improved systems and methods are desired for publishers and advertisers to interface with a federated marketplace for advertising transactions. More specifically, today, a prospective advertiser has no clear mandate for how to spend advertising dollars across different channels, such as radio advertising, TV advertising, Internet advertising, print advertising such as newspapers and phone books, billboards, electronic displays, cell phones, MP3 players, sidewalks, etc. In essence, it can be appreciated that the list of channels advertisers can potentially use to target customers is endless, and yet it is largely decided by individual trial and error today, with results difficult to analyze or compare. Advertisers today are thus left mainly with their intuition as to how to best apportion advertising dollars across disparate channels. Thus, for online advertising marketplaces, what is needed is a way to automatically orchestrate advertising expenditure across different advertising channels on a participant's behalf.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising entities and publishing entities from different advertising networks, the invention provides automatic apportioning of advertising transactions entered into by a participant based on optimal distribution of publishing inventory from different advertising channels. In one embodiment, a participant specifies a set of participation goals and constraints, and then optimal combinations or advertising bundles are generated for the participant based on an analysis of inventory across different advertising channels for the given set of participation goals/constraints.

In addition, a small portion of a participant's overall advertising expenditure can be used for exploratory purposes to determine better combinations of advertising channels based on actual performance, so that over time, a participant can perform better for a given set of participation goals and constraints, based on the identification of market trends or cross channel synergies. In addition to realizing a better return given a participant's advertising goals and constraints, if offered by the same publishing entity, there is an opportunity for the participant to receive a discount from the publishing entity based on the increased purchase volume, further maximizing the participant's advertising expenditure.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the orchestration and/or exploration of disparate advertising channels for an online advertising environment in accordance with the present invention are further described with reference to the accompanying drawings in which:

FIG. 1 is a block diagram of an exemplary advertising marketplace for orchestrating advertising expenditure across advertising channels in accordance with the invention;

FIGS. 2 and 3 are block diagrams of a cross channel orchestration layer provided to a federated advertising marketplace in accordance with the invention;

FIGS. 4, 5A and 5B are block diagrams of exemplary granularities for disparate advertising channels orchestrated in accordance with the invention;

FIG. 6 is an exemplary block diagram illustrating representative flow of the orchestration of transactions across advertising channels in accordance with the invention from the perspective of an advertising entity;

FIG. 7 is an exemplary block diagram illustrating representative flow of the orchestration of transactions across advertising channels in accordance with the invention from the perspective of a publishing entity;

FIG. 8 is a flow diagram of exemplary non-limiting processes performed in accordance with the orchestration and optimization of different advertising channels on behalf of advertising entities in accordance with the invention;

FIG. 9 is a block diagram illustrating exemplary exploration of new combinations of different advertising channels in accordance with alternate embodiments of the invention;

FIG. 10 is a flow diagram illustrating exemplary processes for exploring new combinations of different advertising channels in accordance with alternate embodiments of the invention;

FIG. 11 is a block diagram of a computing system environment suitable for use in implementing the present invention;

FIG. 12 illustrates a distributed architecture for online advertising, according to embodiments of the present invention;

FIG. 13 illustrates one example of the flow of data within an exemplary non-limiting architecture according to embodiments of the present invention;

FIG. 14 illustrates a flowchart of the operation of an exchange, according to exemplary, non-limiting embodiments of the present invention; and

FIG. 15 illustrates a flowchart of the operation of user or a user data broker to provide potentially valuable information according to embodiments of the present invention.

### DETAILED DESCRIPTION

### Overview

In various non-limiting embodiments, the invention is described in the context of federated architectures for online advertising, i.e., a market mechanism that manages the exchange of advertising goods among multiple participants on the advertising and/or publishing side, and across disparate advertising networks that today are exclusive of one another as described in the background. In consideration of the limitations on existing architectures described in the background, the invention enables the orchestration and/or sample exploration of purchasing of advertising by advertisers (or selling of inventory by publishers) across different advertising channels, e.g., Web site ads, TV ads, radio ads, etc, identifying synergies where they exist across advertising channels.

For the avoidance of doubt, as used herein, an advertising channel includes any channel/advertisement relationship, i.e., from the point of view of an advertiser, each channel/advertisement pair can be interpreted as a separate channel. Accordingly, while for simplicity of presentation some embodiments describe a channel having a single kind of content, the invention contemplates creative optimization that is broader. Thus, in non-limiting embodiments, advertisers are allowed to have multiple creatives per channel, e.g., two TV commercials, three radio ads, etc. The invention thus automatically optimizes advertising spend allocation across different channels where channels may refer to different channels including a single kind of content or to different channel/content pairs where multiple kind of content are present.

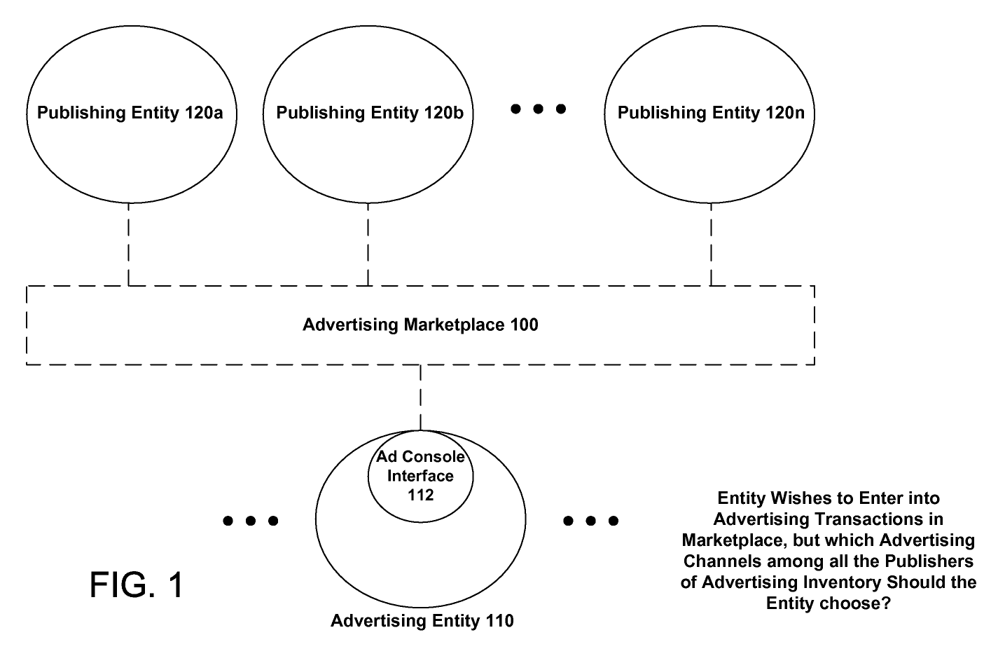

The invention is generally illustrated in the high level block diagram of FIG. 1. As mentioned in the background, today an advertiser 110 participating in an online advertising marketplace 100 via interface 112 faces a morass of publishers 120a, 120b, . . . , 120n, each of which possesses different publishing inventory across different kinds or categories of advertising, i.e., the publishers each service different sets of publishing channels. In this regard, advertising entity 110 may not care what channels are used for its advertising, advertising entity 110 may instead want to maximize relevance to a particular demographic. The invention automates this process of identifying an optimal set of transactions for the advertising entity to pursue across the different advertising channels represented in marketplace 100.

For instance, publisher 120a may have certain syndicated TV programs, a Yellow Pages book and a hard rock radio station as inventory available for ads in the marketplace 100 whereas publisher 120b may have a Web search engine, a billboard in Times Square, NY, and a Sports magazine as available inventory, and so on. As a result, advertising marketplace 100 in aggregate represents a great variety of advertising channels from publisher 120a, 120b, . . . , 120n.

Furthering the example, for a given set of participation goals and/or constraints specified by the advertising entity 110, the invention may operate to indicate to advertising entity 110 that 50% Web based advertising, 25% TV based advertising and 25% radio based advertising will optimize the advertising expenditure of entity 110. Accordingly, the set of transactions recommended by the exchange 100 via interface 112 may apportion spending on the Web search engine, syndicated TV programs and the hard rock radio station of publishers 120a and 120b accordingly. In this way, the invention helps to weight an advertising entity's advertising expenditure across the different advertising channels accordingly. As a result, in effect, participants are prevented from foolishly placing their eggs all in one advertising basket where a diversified set of advertising channels will perform better.

In another aspect, interface 112 in conjunction with marketplace 100 allows advertising entity 110 to specify an experimental advertising expenditure, e.g., 2%, of entity 110's overall advertising expenditure for experimenting across different or new channels. Over time, the 2% will not significantly impact the overall expected return from the entity's advertising expenditure, but the accumulation of results from the transactions purchased by the 2% may yield some valuable information to entity 110. For instance, it may turn out that an obscure blog gets a much higher rate of return than other advertising channels, which informs how the 98% is spent in the future, i.e., the obscure blog becomes part of the optimal set of transactions across disparate advertising channels for entity 110.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follows.

### Orchestration and Exploration of Different Advertising Channels

As mentioned in the background, advertising networks follow a closed, proprietary model that does not automatically tune the performance of a participant's advertising spend across disparate advertising channels. Accordingly, for a multi-party advertising exchange including advertising entities and publishing entities from different advertising networks, the invention provides automatic apportioning of advertising transactions entered into by a participant based on optimal distribution of publishing inventory from different advertising channels. In one embodiment, a participant specifies a set of participation goals and constraints, and then optimal combinations or advertising bundles are generated for the participant based on an analysis of inventory across different advertising channels for the given set of participation goals/constraints.

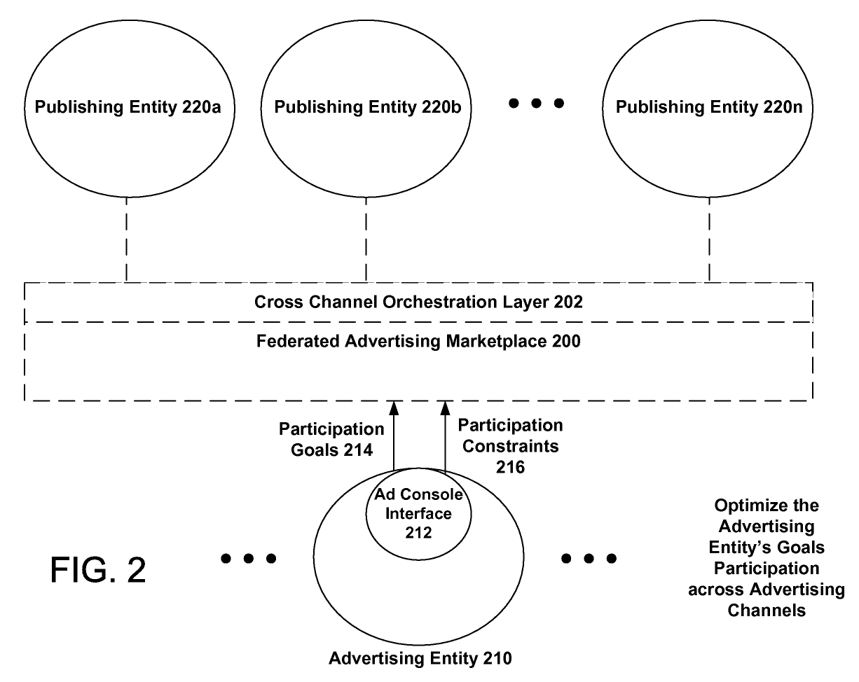

This is illustrated generally in the high level block diagram of FIG. 2 including an advertising entity 210 of numerous advertising entities participating in the marketplace 200. In addition, a wide variety of publishing entities 220a, 220b, 220n participate in the marketplace making available a wide range of advertising channels within marketplace 200. In this regard, entity 210 interacts with federated advertising marketplace 200 via an advertising console interface 212 to specify participation goals 214 for participating in the marketplace 200 (e.g., maximizing or optimizing for revenue, brand name, quality, target demographic, reach, relevance, etc.). Entity 210 may also specify participation constraints 216 for limiting participation in marketplace 200 (e.g., budget limit, no low quality publishing sites, no Web sites that do pop-up ads, audience of at least 50% baby boomers, etc.). Taking into account the entity's goals 214 and constraints 216, the invention operates to automatically orchestrate advertising expenditure across disparate advertising channels, e.g., radio, TV, web, etc., with cross channel orchestration layer 202.

Since there are numerous publishing entities and advertising entities participating in the marketplace 200, over time, according to the law of large numbers, marketplace 200 acquires accurate information about how different advertising performs in different advertising channels for different sets of goals and constraints. As a result, in one embodiment, ad console interface 212 optimizes advertising expenditure on behalf of entities in view of the collective knowledge possessed by marketplace 200 about how transactions have performed across disparate advertising channels in the past.

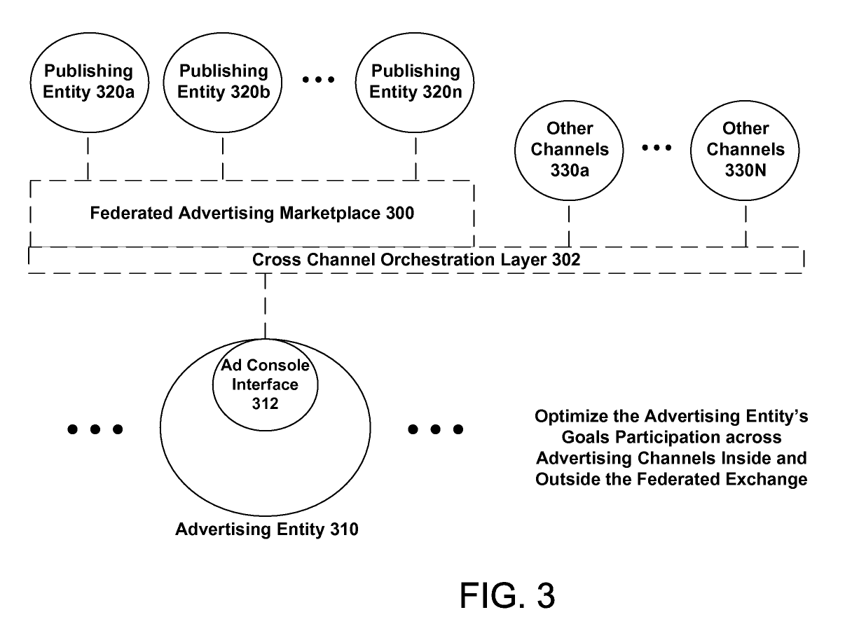

FIG. 3 illustrates an extension of the architecture of the invention wherein, like FIG. 2, an advertising entity 310 has an ad console interface 312 for interfacing to a federated advertising marketplace 300 having a variety of publishing entity 320a, 320b, . . . , 320n, wherein a cross channel orchestration layer 302 orchestrates advertising expenditure across different advertising channels represented by collective publishing inventory. In addition, external channels 330a, . . . , 330N can also plug into the cross channel orchestration layer 302 for additional comparison. For instance, leaflets or physical billboards might be sold outside the federated marketplace 300, however cross channel orchestration layer 302 can provide infrastructure for such external channels to be optimized for advertising entity 310 as well.

Thus, different channels, such as TV ads, radio ads, text ads, web site ads, etc. are orchestrated on behalf of a participant in an online advertising marketplace. As a result, a more holistic view is enabled by the invention for statistics associated with ads in different advertising channels, particularly where the content is highly similar. Advertising channels can be sliced and diced many different ways. Exemplary granularity for advertising channels includes traditionally different markets such as TV ads, radio ads, text ads, web site ads, and other content in other spaces.

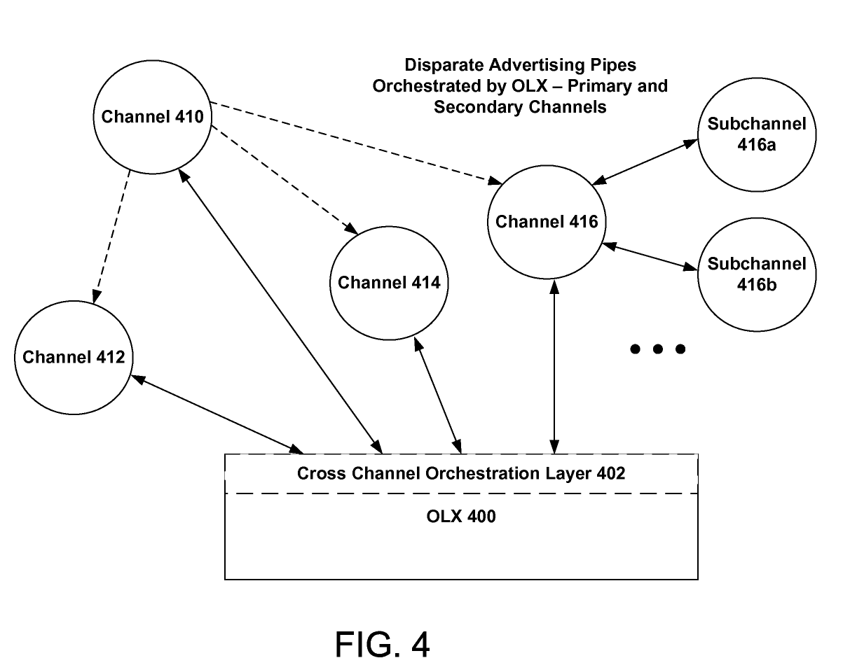

As mentioned, the online advertising exchange of the invention enables the orchestration of advertising content across disparate advertising channels or pipes. As shown in FIG. 4, various different channels 410, 412, 414, 416 can be orchestrated by an orchestration layer 402 of an online exchange 400 in accordance with the invention. Advertising channels can be primary or secondary channels. For instance, channels 412, 414, 416 could be a derivative channel of channel 410. In addition, channels can have subchannels, which can have further subchannels and so on. For instance, channel 416 has subchannels 416a and 416b. Thus, any division and granularity of division of publishing inventory into different avenues that is meaningful to the participants can be adopted.

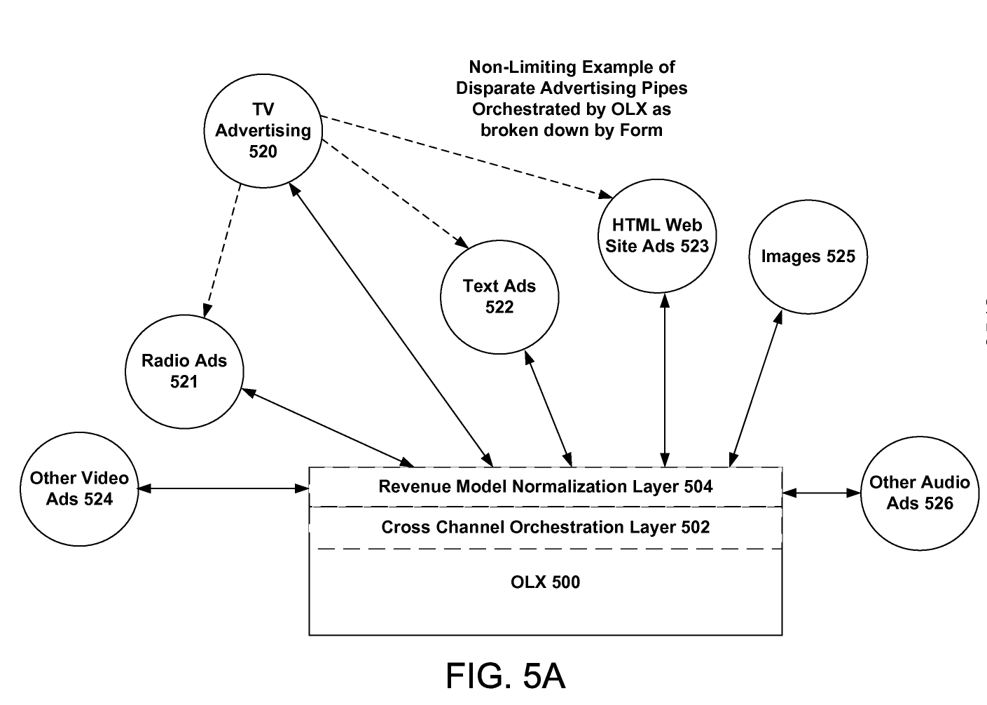

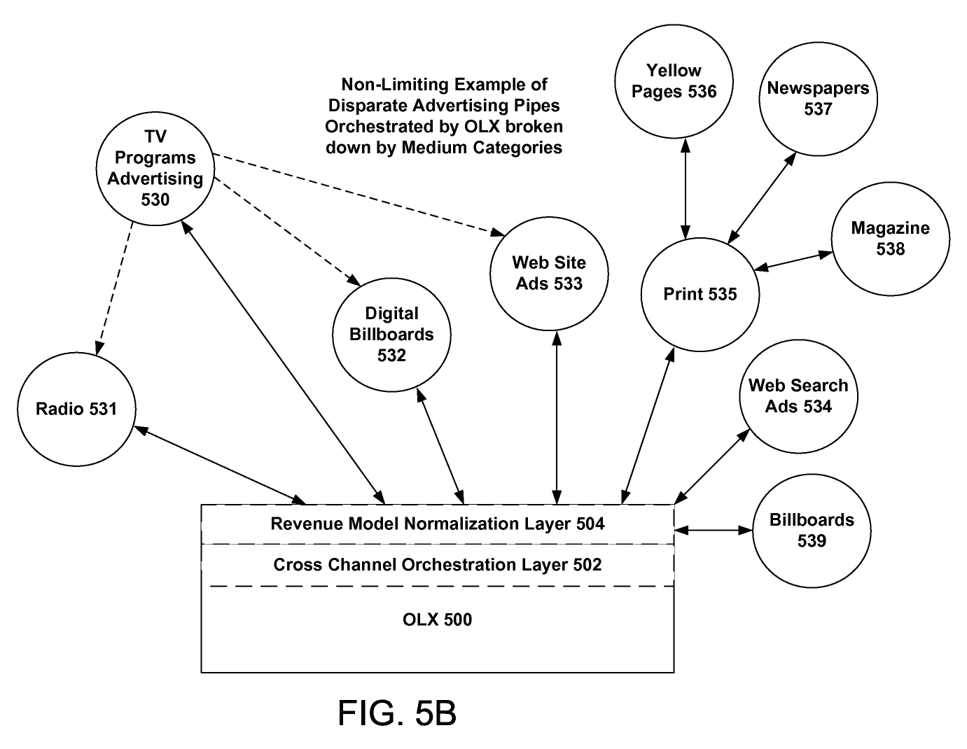

FIGS. 5A and 5B give two representative, non-limiting examples of how publishing inventory might be divided into different channels, which are automatically orchestrated by cross channel orchestration layer 502 in accordance with the invention. For instance, FIG. 5A shows that different channels may include TV advertising 520, radio ads 521, text ads 522, HTML Web site ads 523, other video ads 524, images 525, other audio ads 526, and so forth as input to an online advertising exchange 500 in accordance with the invention. In this regard, in one aspect, the invention operates to normalize advertising across the advertising channels with a normalization layer 504. Normalization layer 504 operates to make different kinds of pricing models comparable within OLX 500, i.e., web site ads are often expressed in terms of cost per impression or cost per click whereas radio ads are sold according to a different pricing model for the time segments since there is no analogous “click” of a radio ad. Thus, normalization layer 504 operates to convert disparate pricing models to a common revenue model enabling direct comparison of different inventory opportunities based on expected value to the advertiser.

As mentioned, a source for advertising in a first channel, such as TV advertising, can be used as a source for derivative advertising in alternate channels. Thus, as shown by the dotted arrows, radio ads 521, text ads 522, and web site ads 523 are each derived from TV advertising 520, i.e., audio from the TV advertising can be aired on radio, video or images on web site ads and text from the advertising can be extracted as well. As a result, the performance of similar advertising across different channels can be observed by OLX 500 via cross channel orchestration layer 502.

FIG. 5A illustrates a sort of division based on the form of the advertising, i.e., whether the inventory hosts, video, images, audio, text, etc. Another kind of division shown in FIG. 5B is with respect to different kinds of distinct mediums for advertising. For instance, TV programs 530 are displayed on a distinct medium from radio 531, which is in turn a different medium from digital billboards 532, and so on for the distinct media for web sites ads 533, print media, web search ads 534 and physical billboards 539. As mentioned, channels can be primary channels or derivative channels of one another. For instance, radio 531, digital billboards 532 and web site ads 533 are shown as derivative channels of TV programs advertising 530. In addition, print media 535 includes subchannels 536, newspapers 537, magazines 538, etc., each of which can be independently tracked by the exchange 500.

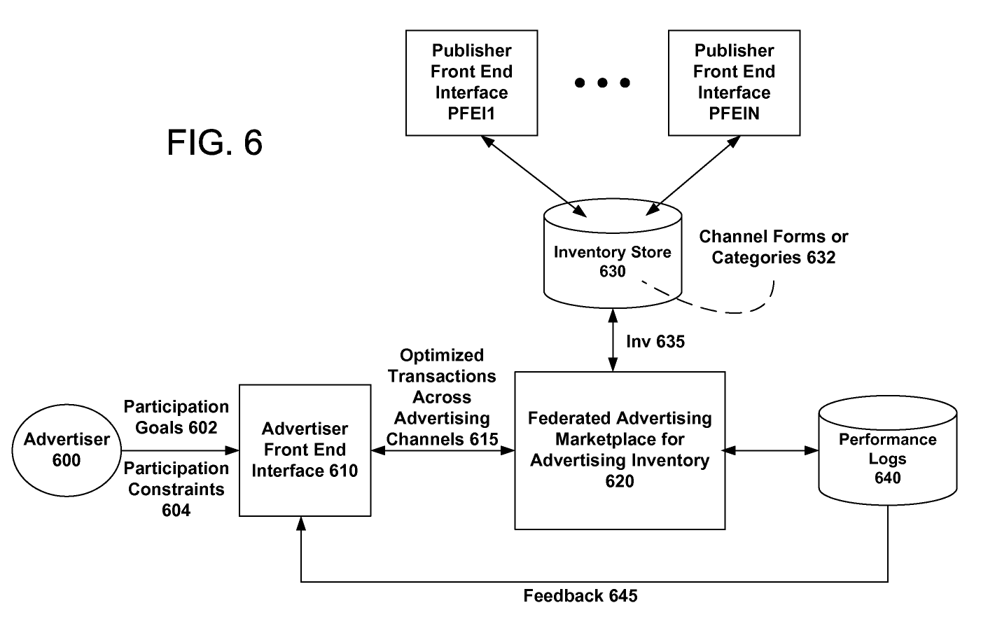

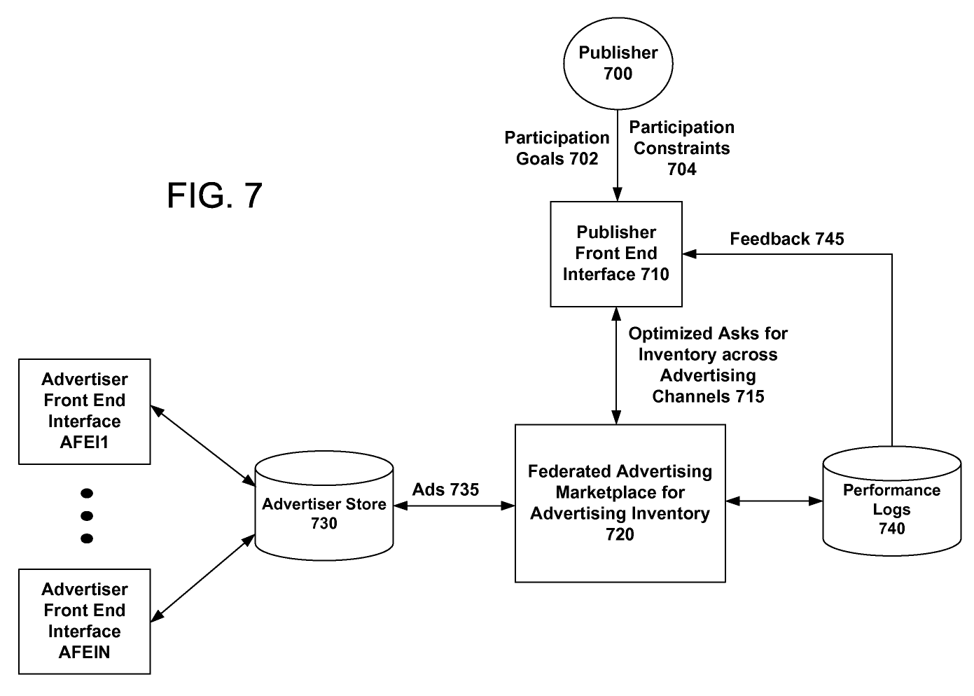

FIGS. 6 and 7 synthesize some of the above-described embodiments to show how the invention can benefit entities on the advertising side and publishing side, respectively. FIG. 6 illustrates the present invention from the perspective of one of many advertising entities, such as an advertiser or advertiser broker, which may be participating in marketplace 620 at any given moment. In accordance with the invention, an advertiser 600 specifies a set of participation goals 602 for interacting with the exchange. A typical goal might be to maximize sales, or expected revenue, however, there are lots of other kinds of goals. For instance, an advertiser might be concerned about publishing quality to preserve brand name, or an advertiser might instead desire low quality to maximize reach. Any reason for advertising by advertiser 600 may constitute a participation goal 602 in accordance with the invention. In addition to participation goals, advertiser 600 may also specify a set of constraints 604 on participation to tailor its advertising strategy in some way. For instance, one example of this is where a particular demographic is desired, e.g., the operator of a mortgage lending web site may wish to exclude minors as a demographic due to their lack of contractual capacity. Advertiser 600 inputs goals 602 and/or constraints 604 into an interface 610 for communicating with the federated marketplace 620.

Meanwhile, publishing entities including individual publishers and publishing brokers interface to the marketplace 620 via publisher front end interfaces PFEI1 to PFEIN to make inventory available to marketplace 620 via inventory store 630. In one embodiment, front end interfaces PFEI1 to PFEIN enable publishers to categorize the inventory, e.g., according to its form or medium 632 as described above, so that transactions can be tracked and analyzed within the exchange 620 according to different advertising channels. Accordingly, based on advertiser's goals 602 and constraints 604 specified via interface 610, the invention operates to automatically make decisions on behalf of advertiser 600 that orchestrate an advertising expenditure across the different categories 632 of inventory in store 630. Advantageously, those decisions result in or return an optimized set of transactions 615 across the different advertising channels for advertiser 600. Moreover, since the performance of transactions across the different advertising channels can be tracked over time in performance logs 640, feedback 645 enables interface 610 to make more accurate forecasts for advertising purchases across different channels as effective channel combinations, trends, synergies, etc. are recognized based on past performance.

FIG. 6 thus describes one way the invention can benefit an advertising entity, i.e., by optimizing the function of the goals 602 of advertiser 600 as limited by constraints 604. FIG. 7 in turn illustrates that publishers can also benefit from the cross channel analysis of a marketplace in accordance with the invention. FIG. 7 includes a set of advertisers from disparate advertising networks participating via advertiser front end interfaces AFEI1 to AFEIN. For instance, bids for advertising can collectively be stored in advertiser store 730 for input of ads 735 to satisfy the buy side of the advertising marketplace 720. In this regard, from the perspective of publisher 700, it might be desirable to know what the best inventory offerings should be for a given set of goals 702 limited by constraints 704. Accordingly, publisher 700 specifies the goals 702 and/or constraints 704 via publisher front end interface 710, and the invention may operate to automatically optimize a set of asks 715 for inventory across different channels in the marketplace 720 to achieve the goals 702 and/or constraints 704. Moreover, as transaction performance is measured across the marketplace 720 in performance logs 740, feedback 745 enables publisher front end interface 710 to identify and optimize which channels are achieving the publisher's participation goals most effectively. Thus, the offering of inventory by publishers across different advertising channels is refined over time in line with actual performance.

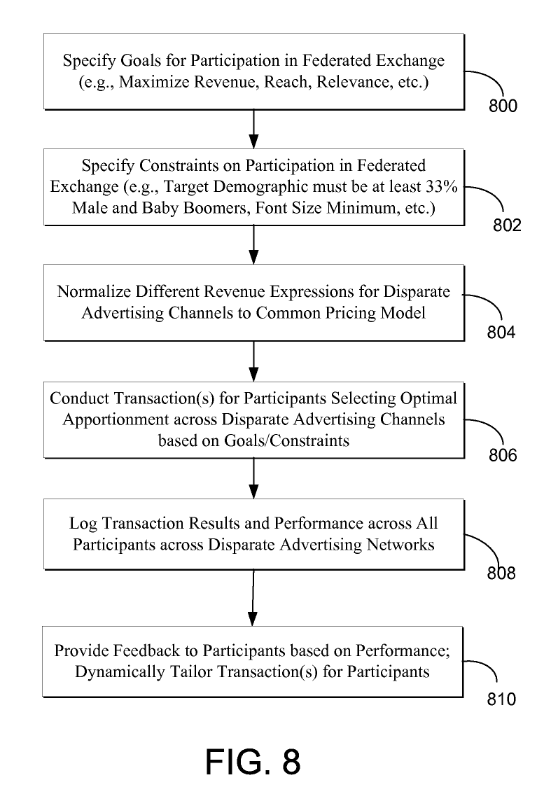

FIG. 8 is a flow diagram of an exemplary, non-limiting method for orchestrating advertising expenditure for an advertising entity of a federated advertising exchange in accordance with the invention. At 800, goals can be specified for participation in the federated exchange (e.g., maximize revenue, reach, relevance, etc.). At 802, constraints are specified for participation in a federated advertising exchange (e.g., target demographic must be 33% male and baby boomers, font minimum size for display, etc.). At 804, different revenue expressions for disparate advertising channels are normalized to a common pricing model. At 806, transactions are automatically conducted for participants that select an optimal apportionment of advertising expenditure across disparate advertising channels based on the specified goals and constraints. At 808, optionally, transaction results and performance across all participants from disparate advertising networks are logged. At 810, feedback is provided to participants based on performance of past transactions which helps to further tune advertising expenditure for a participant to their goals and constraints, e.g., by identifying synergies across channels.

In addition, a small portion of a participant's overall advertising expenditure can be used for exploratory purposes to determine better combinations of advertising channels based on actual performance, so that over time, a participant can perform better for a given set of participation goals and constraints, based on the identification of market trends or cross channel synergies.

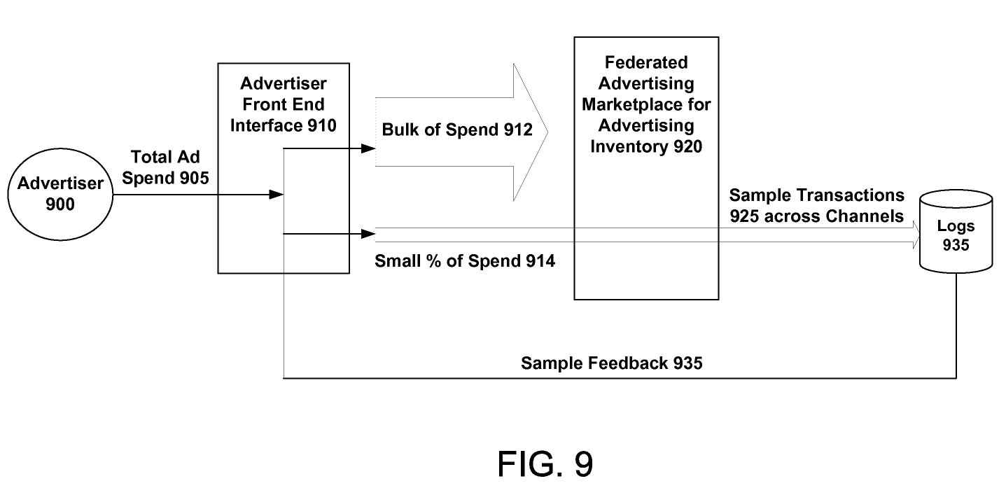

This is generally illustrated in FIG. 9 wherein an advertiser 900 specifies via advertiser front end interface 910 a total advertising expenditure 905 to commit to advertising purchases across disparate channels. As described above, the bulk of the spend 912 can be optimized across disparate channels according to the cross channel orchestration layer of federated advertising marketplace 920 in accordance with the invention. However, according to the presently described embodiment, additionally, a small percentage of the spend 914 can be separated for exploratory purposes, i.e., for buying advertising across a wide distribution of channels. The transactions that result from spending the small percentage of the overall spend 914 in effect become controlled samples 925 for logging the performance of disparate channels. As a result, feedback 935 from the performance of samples 925 informs the rest of the advertising expenditure 912 over time, i.e., once it becomes known that alternate channels better maximize the participant's goals, advertiser front end interface 910 bases future participation on such knowledge, successively converging the advertiser's advertising expenditure on the optimal apportionment of disparate advertising channels. In addition to realizing a better return given a participant's advertising goals and constraints, if offered by the same publishing entity, there is an opportunity for the participant to receive a discount from the publishing entity based on the increased purchase volume, further maximizing the participant's advertising expenditure.

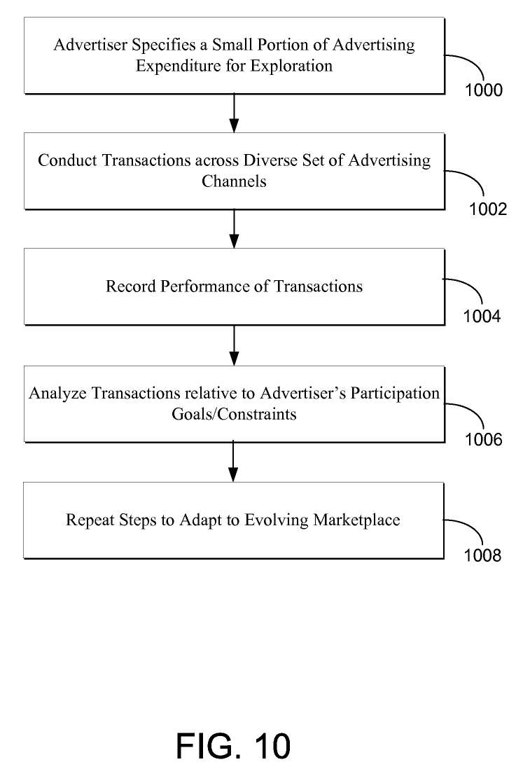

FIG. 10 is a flow diagram of an exemplary, non-limiting method for exploring different advertising channels on behalf of an advertising entity of a federated advertising exchange in accordance with the invention. At 1000, an advertiser specifies a small percentage or small amount of total advertising expenditure for the purpose of exploring different potential advertising channels and different combinations of those channels. At 1002, transactions are conducted across disparate advertising channels for advertising selected by the advertiser. At 1004, the performance of those transactions is logged. At 1006, the performance logs are analyzed in view of the goals/constraints of the advertiser to identify additional channels or combination(s) of channels that the advertiser should pursue as part of an overall advertising strategy. At 1008, the steps are repeated so that the advertising expenditure of the advertiser achieves better expected return over time and continues to improve based on current conditions of the marketplace. Thus, as the supply and demand conditions represented by the marketplace evolve over time, the advertising channels that optimize an advertiser's participation will also evolve. A reason this method is effective over analysis of all transactions in the marketplace is that the advertiser can control the advertising side of the equation for the small portion of the advertising expenditure. For instance, the same or similar or derivative content of a common advertising campaign can be used across all channels as a way of making the analysis of the performance of the different publishing media independent or semi-independent of the advertising displayed.

For instance, in one non-limiting embodiment, the invention provides a tool to advertisers that takes meta-creative content from a first source, e.g., a TV ad, and based on the video, audio, text, etc. of the TV ad, skins for other advertisements can automatically be generated. These derivative advertisements can then be used across the different advertising channels to make comparison of different advertising channels semi-independent of the advertising displayed. As a result, the exchange of the invention perform a better apples versus apples comparison of the statistics associated with the ads in the different advertising channels because the content is highly similar.

As an example, an advertiser may wish to purchase the keyword “flower,” hoping to generate a great lead to a Valentine's Day Florist web site. For such a scenario, the invention provides tools for the Florist to generate advertising content across a variety of channels, e.g., via a template. For instance, a template for a TV advertisement, or a radio advertisement can be used to automatically generate content on par with web site content. As a result, the tools of the invention enables a simple workflow, i.e., specifying content via templates, which then spawns a complex advertising strategy orchestrated across a variety of advertising channels or pipes on behalf of the advertiser. This reduces the amount of intelligence required by the user of the templates to implement advertising across a variety of channels by automatically forming related sets of advertisements.

Having described various non-limiting embodiments of the architectures for participants of a federated advertising framework in accordance with the invention, exemplary non-limiting operating and advertising exchange environments in which the various embodiments may be implemented are now described.

### Exemplary Operating Environment(s)

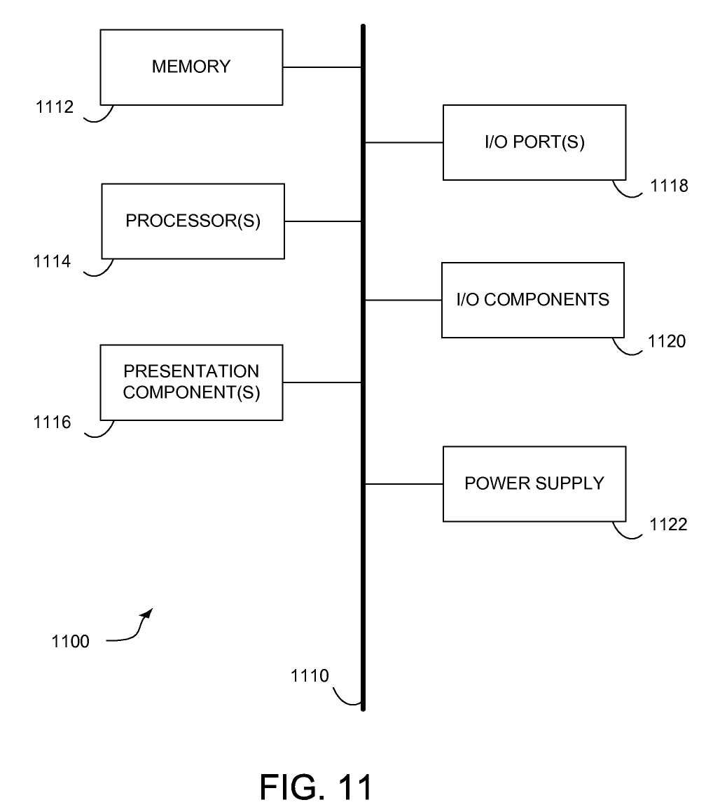

Referring initially to FIG. 11 in particular, an exemplary operating environment for implementing embodiments of the present invention is shown and designated generally as computing device 1100. Computing device 1100 is but one example of a suitable computing environment and is not intended to suggest any limitation as to the scope of use or functionality of the invention. Neither should the computing-environment 1100 be interpreted as having any dependency or requirement relating to any one or combination of components illustrated. In accordance with the invention, participants can communicate with an advertising exchange via one or more computing devices 1100, and the advertising exchange may also comprise one or more computing devices 1100, in order to carry out one or more aspects of the invention described in detail below. As described in detail above, implementations may range from lightweight to heavyweight architectures with respect to how much processing is performed at the front end interface

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 11, computing device 1100 includes a bus 1110 that directly or indirectly couples the following elements: memory 1112, one or more processors 1114, one or more presentation components 1116, input/output ports 1118, input/output components 1120, and an illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 11 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 1100.

Memory 1112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc.

### Exemplary Architecture(s) for Online Advertising

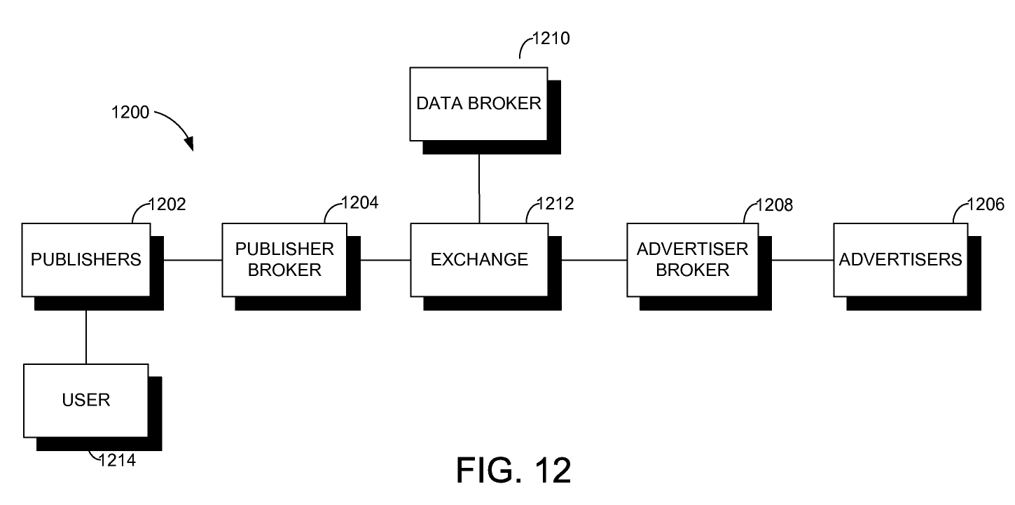

Exemplary online advertising environments for the various architectures in which the present invention may be deployed or implemented are now described. For instance, FIG. 12 illustrates an exemplary distributed architecture 1200 for online advertising, which comprises publishers 1202. For purposes of explanation only, publishers 1202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 1200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 1202 is intended to represent any number of types, sizes, sophistication levels, etc. of publishers. In an embodiment, publishers 1202 desire to sell advertisement space on their websites to advertisers 1206 (discussed below).

Architecture 1200 also comprises publisher broker 1204. For purposes of explanation only, only one publisher broker will be discussed herein. However, embodiments of the present invention are not limited to a single publisher broker, as any number of publisher brokers may exist. In an embodiment, publisher broker 1204 is an aggregator of publishers. Specifically, publisher broker 1204 is an entity that represents publishers 1202 with the goal of maximizing ad revenue, ensuring quality ads, etc. Publisher broker 1204 breaks the conflict of interest that is inherent in systems such as Google's AdSense by solely focusing on managing publishers 1202's yield. Publisher broker 1204 allows small and mid-size publishers (such as those that may be represented by publishers 1202) to aggregate in order to drive higher yield for themselves. In an embodiment, publisher broker 1204 maintains a user interface through which it interacts with publishers 1202 and through which it manages publishers 1202's preferences.

In an embodiment, publisher broker 1204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed and what the publisher broker can expect in terms of a payment.

Architecture 1200 also comprises advertisers 1206. For purposes of explanation only, advertisers 1206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 1200.

In an embodiment, each advertiser purchases ad space on websites. For example, a local business person who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 1206 is intended to represent any number of types, sizes, sophistication levels, etc. of advertisers. In an embodiment, advertisers 1206 desire to pay money to place ads on publishers 1202's websites.

Architecture 1200 also comprises advertiser broker 1208. For purposes of explanation only, only one advertiser broker will be discussed herein. However, embodiments of the present invention are not limited to a single advertiser broker, as any number of advertiser brokers may exist. In an embodiment, advertiser broker 1208 is an aggregator of advertisers. Specifically, advertiser broker 1208 is an entity that represents advertisers 1206 with the goal of optimizing advertisers 1206's spending and placing monetary values on displaying advertising of a particular format, on a particular website, to a particular audience. In an embodiment, advertiser broker 1208 maintains a user interface through which it interacts with advertisers 1206, and through which it manages advertisers 1206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 1200 also comprises exchange 1212. Exchange 1212 acts as a mediator among publisher broker 1204 and advertiser broker 1208. In an embodiment, exchange 1212 routes traffic and facilitates transactions, e.g., auctions, between publisher broker 1204 and advertiser broker 1208. In an embodiment, exchange 1212 is a server or a set of servers.

To provide minimum standards of conformity, in an embodiment, exchange 1212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 1212 sends all publisher broker requests that match a set of criteria defined by the advertiser broker, along with all relevant data about the request (e.g., the ask and collection symbols provided by the publisher and the exchange itself). In an embodiment, if the advertiser broker has any ads that it would like to have displayed and that meet the ask, it returns those ads, up to the number of ads requested, along with a CPI (cost per impression) bid on each. It is noted that CPM (cost per thousand impressions) and CPI are equivalent pricing models with different acronyms. However, embodiments are not limited to CPI pricing, as other pricing models may be used, e.g., CPC (cost per click), CPA (cost per acquisition), and revenue sharing. Exchange 1212 provides a call back to the winning advertiser broker(s) telling it which ads were displayed, and at what prices.

Architecture 1200 also comprises users 1214. For purposes of explanation only, only one user will be discussed herein. However, embodiments of the present invention are not limited to a single user, as any number of users may exist. Users 1214 request a webpage from publishers 1202. The webpage comprises content and advertisement space, which is filled with advertisement(s) from advertisers 1206.

Using architecture 1200, audience data can be provided to advertisers 1206 either by enriching the publishing property with customer intelligence or by acquiring the data directly from a data broker 1210 on the basis of a licensing fee. For instance, advertiser broker 1208 can choose to pay an estimated monthly per volume amount for each attribute that their advertisers are interested in targeting. This transaction could be done off-line but would need to be registered with exchange 1212 to facilitate data rerouting at request time. Advertiser broker 1208 can base its bids on any targeting attributes provided by data broker 1210.

In an embodiment, when publishers 1202 have an impression that they are willing to sell (with an optional ask), they can provide a URL and any targetable values to exchange 1212. Exchange 1212 passes this data and possible additional user data from data broker 1210 to advertiser broker 1208. In an embodiment, advertiser broker 1208 ranks the bids of advertisers 1206 using any proprietary attributes or techniques that it finds useful. For example, advertiser broker 1208 could choose to run keyword extraction or categorization and use this for targeting. Advertiser broker 1208 would output a CPI ranked list of advertisers (in an embodiment, the number would be equal to the number of ads requested by the publisher). In an embodiment, where multiple advertiser brokers exist, exchange 1212 then ranks all ads across all advertiser brokers and chooses the best one (as measured by CPI). If these ads meet or exceed the publisher ask, then exchange 1212 proxies a display of the ads on the publisher website.

A second-price auction can still be applied to facilitate aggressive bidding. Publishers 1202 can get paid on a CPI basis. In an embodiment, exchange 1212 may be used to gate user information originating from publishers 1202. Publishers 1202 can choose to enrich their property with user data and share this information only with selected advertiser brokers.

Because publishers 1202 are concerned with user satisfaction, they would prefer to have some control over the relevancy of the ads placed on their site. Click-through rate is considered a good measure of relevance and therefore many publishers might want minimum click-through guarantees on the ads. Exchange 1212 allows publishers 1202 to optionally specify a minimum click-through rate that is acceptable. Exchange 1212 monitors advertiser broker 1208 to make sure that if it wins these types of asks, then it is meeting the performance guarantees. In an embodiment, if an advertiser broker consistently provides low click-through rates for publisher asks that require a minimum, exchange 1212 may take punitive measures such as suspension from the system.

Advertiser broker 1208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 1208 could multiply the conversion rate by the per conversion bid of the advertiser. The more information available in each request, the better job advertiser broker 1208 can potentially do in predicting the probability of a click or a conversion.

The entity hosting exchange 1212 has access to all data sources, giving it the power to make partial decisions. To alleviate the concern that exchange 1212 will not be impartial both as hosting body and as a direct participant, in an embodiment, transparency will be built into exchange 1212. In that embodiment, exchange 1212 does not have a way to identify brokers of any kind. Also, in that embodiment, advertiser auction algorithms and advertiser to publisher matching algorithms are standardized and transparent to all exchange participants. In an embodiment, no user identifiable information is sent to advertisers 1206 until the user performs an action. Exchange 1212 passes advertiser broker 1208 only the attribute values. Advertisers 1206 do not see the user identifier. At click-time, however, it is still possible for an advertiser to establish a user identifier and associate the bidding profile with that user. For example, exchange 1212 could require a linear value function, and advertisers 1206 would specify a base bid and a bid increment for each attribute value.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Borders as a publisher has a user requesting the page on the “Lonely Planet Guide to Indonesia” and they would like to show ads on that page. They call exchange 1212 with the page URL and information about the user: “Bought four travel books in the last month,” “Bought a book on Bali in the last month,” and “Has clicked on ads before.”

Given the URL, exchange 1212 extracts keywords (“Bali vacations,” “Indonesia travel,” “exotic vacations,” “beach vacations”) and categories (“travel,” “vacations”), and sends this information to each advertiser broker. Each advertiser runs an auction for the impression. The advertiser broker can choose to ask for aggregate bids from advertisers. For example, Expedia might place an aggregate bid of 24 cents, and after subtracting the licensing fees, their base bid would be equal to 20 cents. Expedia's advertiser broker needs first to subtract all incremental bids and to assign credit to the publisher as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. The publisher was not able to assess the household income of the user so this incremental bid is not used. The 1 cent incremental bid for the search user patterns will be credited to MSNSearch. After the appropriate credit distribution the advertiser broker would assign a publisher value bid (the base bid + any incremental publisher bids) to each advertiser. In case of Expedia publisher value bid would be equal to 27 cents.

Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad gets served on Border's page. The user clicks on the ad. The user buys a two-week vacation to Bali.

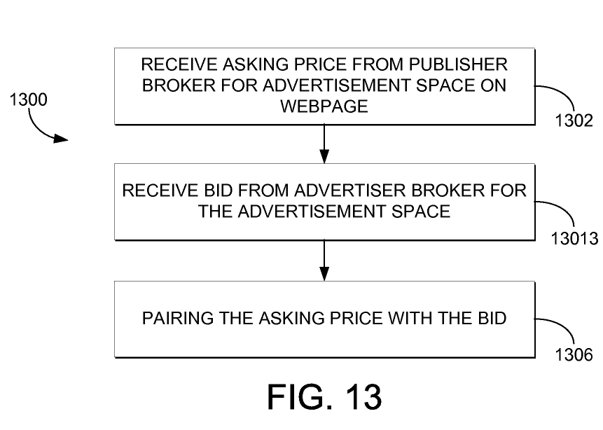

FIG. 13 illustrates a flowchart of the operation of an exchange, according to embodiments of the present invention. Referring to FIG. 13, method 1300 begins with the receipt of an ask from a publisher broker for advertisement space on a webpage (1302). A bid is received from an advertiser broker for the advertisement space (1304). In an embodiment, bids are received from many different advertiser brokers. The ask is paired with one of the bids (1306) and the advertisement space on the webpage is awarded to the winning bidder. As discussed in greater detail above, other information such as user attributes may be attached to the ask, and quality of the bidding advertisers may be examined prior to the advertisement space being awarded.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

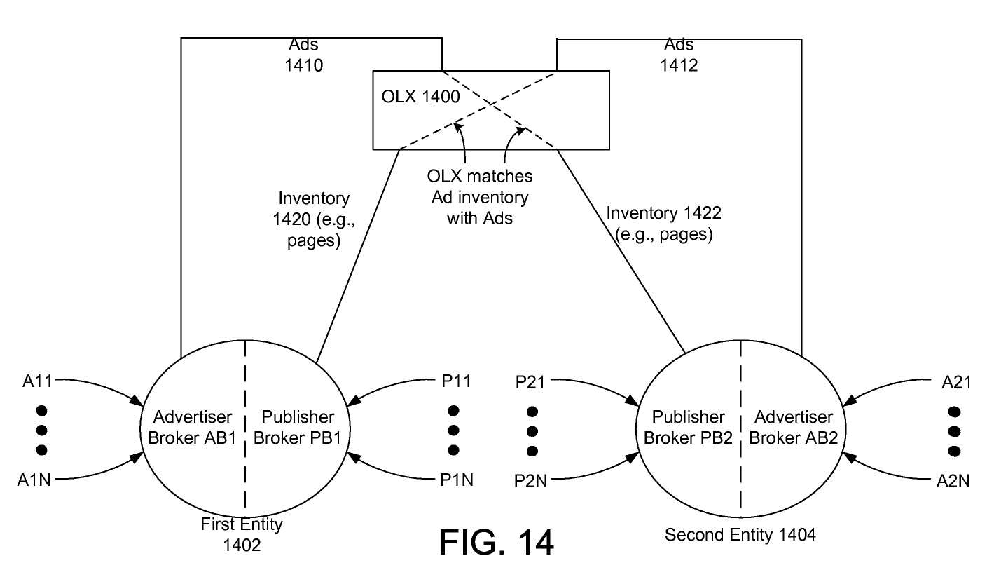

The invention thus can operate in a system that enables broad liquidity over distributed advertising markets, such as the above-described advertising exchange systems. FIG. 14 illustrates a conceptual block diagram of an on-line advertising exchange 1400 provided in accordance with the invention. As shown, a first entity 1402 and a second entity 1404 are subscribers to the services of exchange 1400. First entity 1402 may have an advertiser broker AB1 for brokering advertisements 1410 from a variety of sources A11 thru A1N and a publisher broker PB1 for brokering inventory 1420 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 1404 may have an advertiser broker AB2 for brokering advertisements 1412 from a variety of sources A21 thru A2N and a publisher broker PB2 for brokering inventory 1422 from a variety of publishers P21 thru P2N.

By providing ads 1410 and 1412 to OLX 1400 according to a first communications layer, and by providing inventory 1420 and 1422 to OLX 1400 according to an independent communications layer, OLX 1400 can efficiently match advertisements to available inventory with greater simultaneous knowledge of multiple advertising networks.

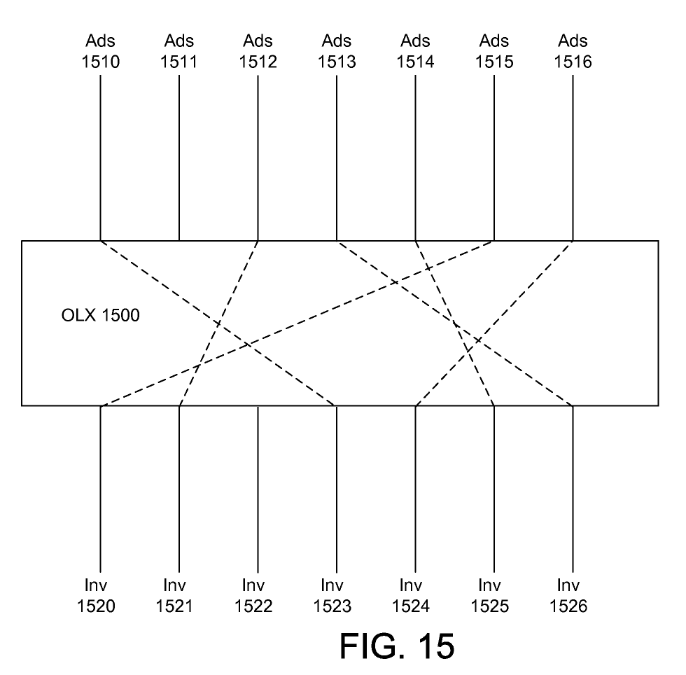

For instance, first entity 1402 might be Microsoft's MSN Web site, and second entity 1404 might be Yahoo's portal Web site. For simplicity, FIG. 14 illustrates only two entities, but advantageously, the invention can also be scaled to accommodate any number of advertising networks, e.g., eBay, Amazon, Google, etc. This is illustrated in FIG. 15 showing an OLX 1500 that accommodates a wide range of advertising 1510, 1511, 1512, 1513, 1514, 1515, 1516, etc. from a wide range of parties, and also accommodates a wide range of inventory 1520, 1521, 1522, 1523, 1524, 1525, 1526, etc. from a wide range of parties. OLX 1500 then makes the best assessment of how to match advertising content with inventory according to a variety of policies (e.g., maximizing ad revenue, maximizing quality of advertising, maximizing conversion rate, etc.). While various non-limiting embodiments of the invention are described in the context of two parties herein, this is for ease of conceptual presentation. It can be appreciated that the invention can be provided for any arbitrary number of advertising entities wishing to join the exchange 1500.

As mentioned, the invention may be implemented in a peer-to-peer architecture, wherein processing performed by the exchange of the invention is shared across multiple participating machines. In such a non-limiting embodiment, each machine participating in the exchange network enabled by the invention can share some of the processing associated with the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described sura, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for facilitating transactions for advertisement space from different advertising channels in a federated advertising exchange, comprising:
receiving at least one participation objective from an advertising entity participating in the federated advertising exchange; and
based on the at least one participation objective, automatically optimizing advertising expenditure of the advertising entity for a set of prospective transactions in the federated advertising exchange across advertisement space from different advertising channels available in the federated advertising exchange.

2. The method of claim 1, wherein the receiving includes receiving at least one participation constraint that limits the at least one participation objective.

3. The method of claim 1, further comprising:
normalizing pricing models associated with the different advertising channels to a common pricing model based on expected revenue.

4. The method of claim 1, further comprising:
reserving a portion of the advertising expenditure to conduct additional transactions for advertisement space from different combinations of the advertising channels; and
analyzing the performance of the additional transactions to improve said optimizing.

5. The method of claim 4, further comprising:
generating derivative advertisements that are same as or similar to a template advertisement for the different combinations of the advertising channels enabling performance of the additional transactions to be substantially independent of advertising content.

6. The method of claim 1, further comprising:
recording the performance of past transactions conducted in the federated advertising exchange across all of the different advertising channels, and wherein the optimizing includes automatically optimizing, based on the at least one participation objective and the performance of past transactions conducted in the federated advertising exchange, the advertising expenditure of the advertising entity for the set of prospective transactions across advertisement space from different advertising channels.

7. The method of claim 1, wherein the optimizing includes automatically optimizing, based on the at least one participation objective, advertising expenditure of the advertising entity for the set of prospective transactions in the federated advertising exchange across advertisement space from different advertising channels and sub-channels available in the federated advertising exchange.

8. The method of claim 1, wherein the optimizing includes automatically optimizing, based on the at least one participation objective, advertising expenditure of the advertising entity for the set of prospective transactions in the federated advertising exchange across advertisement space from at least two of radio, TV program, billboard, web site, web search or print advertising channels.

9. The method of claim 1, wherein the optimizing includes automatically optimizing, based on the at least one participation objective, advertising expenditure of the advertising entity for the set of prospective transactions in the federated advertising exchange across advertisement space from at least two of video, images, audio and text advertising channels.

10. A computer readable medium comprising computer executable instructions for performing the method of claim 1.

11. A method for facilitating transactions for advertisement space from different advertising channels in a federated advertising exchange, comprising:
with at least a portion of advertising expenditure specified by an advertising entity, conducting a set of transactions in the federated advertising exchange across different combinations of disparate advertising channels represented by publishing inventory made available in the federated advertising exchange;
analyzing the performance of the set of transactions; and
based on the performance of the set of transactions across different combinations of disparate advertising channels, optimally apportioning another portion of advertising expenditure of the advertising entity across the disparate advertising channels for additional transactions conducted in the federated advertising exchange.

12. The method of claim 11, wherein the apportioning includes optimizing at least one participation goal of the advertising entity in view of at least one participation constraint that limits the at least one participation goal.

13. The method of claim 11, further comprising:
normalizing pricing models associated with the disparate advertising channels to a common pricing model.

14. The method of claim 11, further comprising:
receiving a template advertisement; and
automatically generating advertisements for the set of transactions that are same as or similar to the template advertisement enabling performance of the additional transactions to be substantially independent of differences in advertising content across the different transactions of the set of transactions.

15. The method of claim 11, wherein the apportioning includes automatically apportioning another portion of advertising expenditure of the advertising entity across at least two of radio, TV program, billboard, web site, web search or print advertising channels.

16. A computing device comprising means for performing the method of claim 11.

17. A system to facilitate trading of advertising, comprising:
at least one publisher broker to represent at least one publisher, wherein the at least one publisher broker determines at least one ask for publishing inventory of the at least one publisher from different advertising channels;
at least one advertiser broker to represent at least one advertiser, wherein the at least one advertiser broker manages at least one bid for the publishing inventory by the at least one advertiser;
an exchange to facilitate transactions for the publishing inventory between the at least one publisher broker and the at least one advertiser broker, and
at least one tool that receives from a publisher broker or an advertiser broker a definition of at least one utility function applying to participation in the exchange, wherein the at least one tool automatically orchestrates the transactions for the publishing inventory across the different advertising channels by automatically apportioning the transactions across publishing inventory of different advertising channels to optimize the at least one utility function of the publisher broker or the advertiser broker.

18. The system of claim 17, wherein the exchange normalizes the publishing inventory of the at least one publisher from different advertising channels to a common revenue model within the exchange for comparison of publishing inventory from the different advertising channels.

19. The system of claim 17, wherein the advertiser broker or publisher broker is the advertiser broker and wherein the at least one tool enters into, on behalf of the advertiser broker, additional transactions including differing combinations of publishing inventory from different advertising channels and the at least one tool analyzes the performance of the additional transactions to improve the apportioning of transactions across publishing inventory.

20. The system of claim 17, wherein the at least one tool automatically optimizes, based on at least one participation objective, the transactions in the federated advertising exchange across publishing inventory from at least two of radio, TV program, billboard, web site, web search or print advertising channels or subchannels.
